(19) United States
(12) Patent Application Publication
(10) Pub. No.: US 2016/0297232 A1
(43) Pub. Date: Oct. 13, 2016

(54) SECURE DOCUMENT AND METHOD OF PRODUCTION OF SAID SECURE DOCUMENT

(71) Applicant: GEMALTO S.A., Meudon (FR)

(72) Inventor: Jean-Luc LESUR, Meudon (FR)

(73) Assignee: GEMALTO SA, Meudon (FR)

(21) Appl. No.: 15/100,705

(22) PCT Filed: Oct. 9, 2014
(86) PCT No.: PCT/EP2014/071690

§ 371 Date: Jun. 1, 2016

(30) Foreign Application Priority Data
Dec. 2, 2013 (EP) 13306652.2

(51) Int. Cl. B42D 25/435; B42D 25/309; B41M 3/14; B41J 2/44; B41J 2/455; B41M 3/00; B42D 25/29; B42D 25/23

(52) U.S. Cl. CPC B42D 25/435; B42D 25/29; B42D 25/309; B42D 25/23; B41J 2/442; B41J 2/455; B41M 3/008; B41M 3/14

(57) ABSTRACT

The present invention concerns a secure document comprising at least a personalized rainbow color micro-text with a text height inferior or equal to 300 μm. The invention also concerns the method of production of said secure document. The present invention also concerns a method of production of a secure document comprising at least a personalized rainbow color micro-text with a text height inferior or equal to 300 μm, said method comprising at least the following steps:—printing a rainbow color pattern on a predefined area of the secure document,—laser marking on the rainbow pattern of the predefined area, in order to form the personalized rainbow color micro-text on said predefined area. The laser marking can be laser blackening, laser whitening or a laser color change.

The present invention concerns a secure document. More precisely, the present invention concerns a secure document incorporating anti-forger and authentication means.

It is known to incorporate authentication means like a micro-text on a secure document in order to guarantee its authenticity. A micro-text is a small text printed on the secure document and works as an anti-counterfeiting feature through the fact that text of such small size is very difficult to reproduce accurately during attempts to counterfeit the secure document on which it is printed. When said secure document is placed in a photocopier or computer scanner, a line of micro-text may appear to the copier or scanner as a dotted or solid line if the scanning resolution is too low. Likewise, with a commercial printer it may be difficult to reproduce the micro-text, which will then appear in the same manner on the counterfeit document when it is printed. Likewise, attempts to counterfeit using a printing press do not accurately reproduce the micro-text, because the text is too small to engrave into the printing plates using methods available to the general public and to counterfeiters.

However, commercial printers and scanners improve each day their resolution due to the progress of technology and the cost reduction of the devices. So it is now easier for a counterfeit to copy and reproduce a micro-text.

An object of the invention, among others, is thus to provide an improved and secure document comprising a micro-text and where said micro-text is difficult to copy and/or print for a counterfeit.

The present invention concerns a method of production of a secure document comprising at least a personalized rainbow color micro-text with a text height inferior or equal to 300 μm, said method comprising at least the following steps:
printing a rainbow color pattern on a predefined area of the secure document,
laser marking on the rainbow pattern of the predefined area, in order to form the personalized rainbow color micro-text on said predefined area.
This method of production allows obtaining a personalized rainbow color micro-text with a text height inferior or equal to 300 μm.

According to an aspect of the invention, the laser marking step is a laser blackening step of the rainbow color pattern on the predefined area in order to form the contours of the rainbow color micro-text.

According to another aspect of the invention, the laser marking step is a laser whitening step of the rainbow color pattern on the predefined area in order to form the contours of the rainbow color micro-text.

According to another aspect of the invention, the rainbow color pattern on the predefined area changes color under the effect of three laser of predetermined wavelength corresponding to the three primary colors and the laser marking step is a laser color change of the rainbow color pattern on the predefined area in order to form the rainbow color micro-text.

According to another aspect of the invention, the laser marking step uses at least one pulsed laser.

According to another aspect of the invention, the pulsed laser has a Gaussian curve of power of its beam and the dots generated by the impact of this pulse laser, have a gradient effect between their center and their periphery. So the rainbow effect can be made also inside the dots which can be of 20 μm diameter.

The present invention also concerns a secure document comprising at least a personalized rainbow color micro-text with a text height inferior or equal to 300 μm.

The personalized rainbow color micro-text is harder to copy or reproduce than a standard black micro-text due to its rainbow color and its height. Indeed, a rainbow color pattern with a text height inferior or equal to 300 μm can't be scanned or read by a standard scanner and inkjet or a Dye Diffusion Thermal Transfer system (D2T2) cannot reproduce such detailed and colored micro-text.

According to an aspect of the secure document of the invention, the personalized rainbow color micro-text appears in contrast on a monochrome predefined area of the secure document.

According to another aspect of the secure document of the invention, the personalized rainbow color micro-text appears in contrast on a black predefined area of the secure document.

According to another aspect of the secure document of the invention, the personalized rainbow color micro-text appears in contrast on a white predefined area of the secure document.

According to another aspect of the secure document of the invention, the personalized rainbow color micro-text appears in contrast on a rainbow color predefined area of the secure document.

According to another aspect of the secure document of the invention, the personalized rainbow color micro-text or a predefined area surrounding said personalized rainbow color micro-text contains dots having a gradient effect.

The invention is explained in greater detail below with reference to the accompanying figures in which:

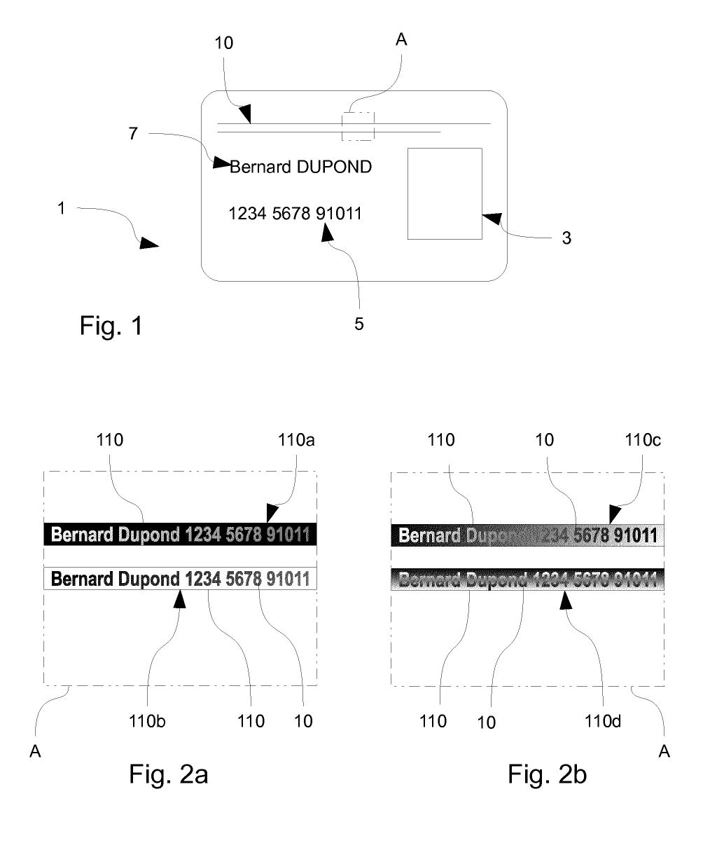

the FIG. 1 represents a secure document according to the invention,

the FIGS. 2a and 2b represent an enlargement of the micro-text of the secure document of FIG. 1.

In these figures, the same references refer to the same elements.

The FIG. 1 represents a secure document 1, more precisely the represented secure document 1 is a card comprising security means 3; 5; 7; 10 in order to authenticate said secure document 1. However, a secure document 1 according to the invention could be any other document than a card as any other secure document 1 comprising security means 3; 5; 7; 10.

These security means 3; 5; 7 and 10 could be any known security means like identity photography 3 of the user, a specific serial number 5, the identity mane 7 of the user. The security means of the secure document 1 could also comprise a personalized rainbow color micro-text 10 having a text height inferior or equal to 300 μm.

This personalized rainbow color micro-text 10 is more visible on FIGS. 2a and 2b representing an enlargement of the portion A of the secure document 1 of FIG. 1.

The personalized rainbow color micro-text 10 is harder to copy or reproduce than a standard black micro-text due to its rainbow color and its height. Indeed, a rainbow color pattern with a text height inferior or equal to 300 μm can't be scanned or read by a standard scanner and inkjet or a Dye Diffusion Thermal Transfer system (D2T2) cannot reproduce such detailed and colored micro-text 10.

By personalized, we mean that the micro-text 10 has a specific text related to the secure document 1. So the personalized rainbow color micro-text 10 is unique and can vary from one secure document 1 to another. For example, in FIGS. 2a and 2b, the personalized rainbow color micro-text 10 reproduces information contained in other security means like the identity 7 of the user and the specific serial number 5.

The personalized rainbow color micro-text 10 appears in contrast on a predefined area 110 of the secure document 1. This predefined area 110 surrounds the personalized rainbow color micro-text 10.

In a first and a second embodiments represented on FIG. 2a, the personalized rainbow color micro-text 10 appears in contrast on a monochrome predefined area 110a, 110b. More precisely, this monochrome predefined area 110a, 110b could be a black predefined area 110a or it could be a white predefined area 110b.

In a third embodiment represented on FIG. 2b, the personalized rainbow color micro-text 10 appears in contrast on a rainbow color predefined area 110a, 110b. The rainbow color predefined area 110c, 110d could have different gradient direction, for example a right to left linear gradient direction like the rainbow color predefined area 110c or an up to down linear gradient direction like the rainbow color predefined area 110d.

The present invention also concerns a method of production of a secure document 1 comprising at least a personalized rainbow color micro-text 10 with a text height inferior or equal to 300 μm.

The method of production according to the invention takes place during the standard personalization phase of a secure document 1. In this well known personalization phase, information and authentication means like identity photography 3 of the user, specific serial number 5 and the identity 7 of the user, are printed and applied on the secure document 1.

This method of production also comprises at least the following steps:
printing a rainbow color pattern on a predefined area 110 of the secure document 1.

The rainbow color pattern on the predefined area 110 could have different gradient direction, for example a right to left linear gradient direction or an up to down linear gradient direction.
laser marking on the rainbow pattern of the predefined area 110, in order to form the personalized rainbow color micro-text 10 on said predefined area 110.

This laser marking step could be realized for example by at least one pulsed laser with a power of two Watt.

This method of production allows obtaining a personalized rainbow color micro-text 10 with a text height inferior or equal to 300 μm. With this method of production it is easily possible to obtain a personalized rainbow color micro-text 10 with a text height of 200 μm.

In a first embodiment shown in FIG. 2a, the laser marking step is a laser blackening step of the rainbow color pattern on the predefined area 110 in order to form the contours of the rainbow color micro-text 10. This laser blackening could be done for example by an yttrium aluminium garnet (YAG) laser.

In a second embodiment also shown in FIG. 2a, the laser marking step is a laser whitening step of the rainbow color pattern on the predefined area 110 in order to form the contours of the rainbow color micro-text 10. This laser whitening step could be done for example by an ultraviolet (UV) laser bleaching the rainbow color pattern on the predefined area 110. Another possibility for this laser whitening step is to remove the rainbow color pattern on the predefined area 110 in order to form the contours of the rainbow color micro-text 10, for example with an infrared (IR) or CO₂ laser.

In a third embodiment shown in FIG. 2b, the laser marking step is a laser color change of the rainbow color pattern on the predefined area 110 in order to form the rainbow color micro-text 10. In this third embodiment, the color of the rainbow color pattern on the predefined area 110 changes under the effect of three laser of predetermined wavelength corresponding to the three primary colors and these lasers form the rainbow color micro-text 10 by changing the color of the predefined area 110 on the location of the signs forming the micro-text 10.

Due to the Gaussian curve of power of the laser beam between the center and the periphery of the beam, on every dot produced by the impact of the pulsed laser beam on the rainbow color pattern on the predefined area 110, there is a different color change between the center and the periphery of said dot generating a gradient effect on each dot.

This gradient effect on the dots could be obtained on the blackened or whitened predefined area 110a, 110b or on the dots changing the colors of the rainbow color pattern on the predefined area 110c, 110d in order to form the rainbow color micro-text 10.

This gradient effect on the dots enhances the security of the secure document 1 because such effect is very difficult to reproduce.

Thus, the secure document 1 and the method of production of said secure document 1 according to the invention ensure a high level of security and authentication due to the presence of the personalized rainbow color micro-text which is difficult to scan or reproduce.

1. A method of production of a secure document comprising at least a personalized rainbow color micro-text with a text height inferior or equal to 300 μm, said method comprising at least the following steps:
printing a rainbow color pattern on a predefined area of the secure document,
laser marking on the rainbow pattern of the predefined area, in order to form the personalized rainbow color micro-text on said predefined area.

2. The method according to claim 1, wherein the laser marking step is a laser blackening step of the rainbow color pattern on the predefined area in order to form the contours of the rainbow color micro-text.

3. The method according to claim 1, wherein the laser marking step is a laser whitening step of the rainbow color pattern on the predefined area in order to form the contours of the rainbow color micro-text.

4. The method according to claim 1, wherein the rainbow color pattern on the predefined area changes color under the effect of three lasers of predetermined wavelength corresponding to the three primary colors and wherein the laser marking step is a laser color change of the rainbow color pattern on the predefined area in order to form the rainbow color micro-text.

5. The method according to claim 1, wherein the laser marking step uses at least one pulsed laser.

6. The method according to claim 5, wherein the at least one pulsed laser has a Gaussian curve of power of its beam and that the dots
generated by the impact of this pulsed laser, have a gradient effect between their center and their periphery.

7. Secure document wherein said secure document comprises at least a personalized rainbow color micro-text with a text height inferior or equal to 300 μm.

8. The secure document according to claim 7, wherein the personalized rainbow color micro-text appears in contrast on a monochrome predefined area of the secure document.

9. The secure document according to claim 8, wherein the personalized rainbow color micro-text appears in contrast on a black predefined area of the secure document.

10. The secure document according to claim 8, wherein the personalized rainbow color micro-text appears in contrast on a white predefined area of the secure document.

11. The secure document according to claim 7, wherein the personalized rainbow color micro-text appears in contrast on a rainbow color predefined area of the secure document.

12. The secure document according to claim 7, wherein the personalized rainbow color micro-text or a predefined area surrounding said personalized rainbow color micro-text contains dots having a gradient effect.
